(19) United States
(12) Patent Application Publication
(10) Pub. No.: US 2014/0365708 A1
(43) Pub. Date: Dec. 11, 2014

(54) CONTROL APPARATUS AND METHOD FOR CONTROLLING CONTROL APPARATUS

(71) Applicant: KABUSHIKI KAISHA YASKAWA DENKI, Kitakyushu-shi (JP)

(72) Inventors: Yoshihiro IWATA, Kitakyushu-shi (JP); Naoyoshi ISHIBASHI, Kitakyushu-shi (JP); Michiharu TANAKA, Kitakyushu-shi (JP)

(73) Assignee: KABUSHIKI KAISHA YASKAWA DENKI, Kitakyushu-shi (JP)

(21) Appl. No.: 14/468,340

(22) Filed: Aug. 26, 2014

Related U.S. Application Data
(63) Continuation of application No. PCT/JP2012/054969, filed on Feb. 28, 2012.

(51) Int. Cl. G06F 3/06; G05B 15/02

(52) U.S. Cl. CPC G06F 3/0629; G05B 15/02; G06F 3/0604; G06F 3/0683; G06F 2003/0697
USPC 711/102

(57) ABSTRACT

A control apparatus includes a signal processing module. The signal processing module includes a field programmable gate array and a volatile memory. The volatile memory is configured to store configuration information of the field programmable gate array. The field programmable gate array has access to the volatile memory after a configuration of the field programmable gate array.

### CROSS-REFERENCE TO RELATED APPLICATIONS

The present application is a continuation application of International Application No. PCT/JP2012/054969, filed Feb. 28, 2012. The contents of this application are incorporated herein by reference in their entirety.

### BACKGROUND

1. Technical Field

The embodiments disclosed herein relate to a control apparatus and a method for controlling a control apparatus.

2. Discussion of the Background

Japanese Unexamined Patent Application Publication No. 2000-105759 discloses a control apparatus including a signal processing module provided with a field programmable gate array.

Specifically, Japanese Unexamined Patent Application Publication No. 2000-105759 discloses an integrated circuit including a field programmable gate array (FPGA) and a non-volatile programmable read-only memory (PROM). The PROM stores logic data (configuration information) for programming the FPGA as a CPU core (processor). An exemplary application of the integrated circuit is to a signal processing module of a control apparatus. Generally, to program the FPGA as a circuit having a desired function is referred to as a configuration.

### SUMMARY

According to one aspect of the present disclosure, a control apparatus includes a signal processing module. The signal processing module includes a field programmable gate array and a volatile memory. The volatile memory is configured to store configuration information of the field programmable gate array. The field programmable gate array has access to the volatile memory after a configuration of the field programmable gate array.

According to another aspect of the present disclosure, a control apparatus includes a signal processing module. The signal processing module includes a field programmable gate array and a volatile memory. The volatile memory is configured to store configuration information of the field programmable gate array. The field programmable gate array has access to the volatile memory after a configuration of the field programmable gate array. When the configuration of the field programmable gate array is performed based on the configuration information stored in the volatile memory, the field programmable gate array is configured to function as a processor of the signal processing module. The volatile memory is configured to store an operation program of the processor. The processor is configured to operate based on the operation program stored in the volatile memory.

According to the other aspect of the present disclosure, a method is for controlling a control apparatus. The control apparatus includes a control module and a signal processing module. The control module includes a central processing unit and a signal processing module. The signal processing module includes a field programmable gate array and a volatile memory. The method includes obtaining configuration information of the field programmable gate array from the control module and storing the configuration information in the volatile memory. A configuration is performed based on the configuration information stored in the volatile memory so as to make the field programmable gate array function as a processor of the signal processing module. The processor is allowed to have access to the volatile memory so as to perform processing using the processor.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating a general arrangement of a programmable logic controller (PLC) according to a first embodiment;

FIG. 2 is a block diagram illustrating a specific structure of a CPU module and a signal processing module of the PLC according to the first embodiment;

FIG. 3 is a flowchart illustrating a processing flow on the CPU module side at the time of a configuration of a field programmable gate array (FPGA) of the signal processing module at power-up of the PLC according to the first embodiment;

FIG. 4 is a flowchart illustrating a processing flow on the signal processing module (image processing module) side at the time of the configuration of the FPGA of the signal processing module at power-up of the PLC according to the first embodiment;

FIG. 5 is a block diagram illustrating a specific structure of a CPU module and a signal processing module of a PLC according to a second embodiment;

FIG. 6 is a block diagram illustrating a specific structure of a CPU module and a signal processing module of a PLC according to a first modification of the first embodiment;

FIG. 7 is a block diagram illustrating a specific structure of a CPU module and a signal processing module of a PLC according to a second modification of the first embodiment; and

FIG. 8 is a block diagram illustrating a specific structure of a CPU module and a signal processing module of a PLC according to a third modification of the first embodiment.

### DESCRIPTION OF THE EMBODIMENTS

The embodiments will now be described in detail with reference to the accompanying drawings, wherein like reference numerals designate corresponding or identical elements throughout the various drawings.

### First Embodiment

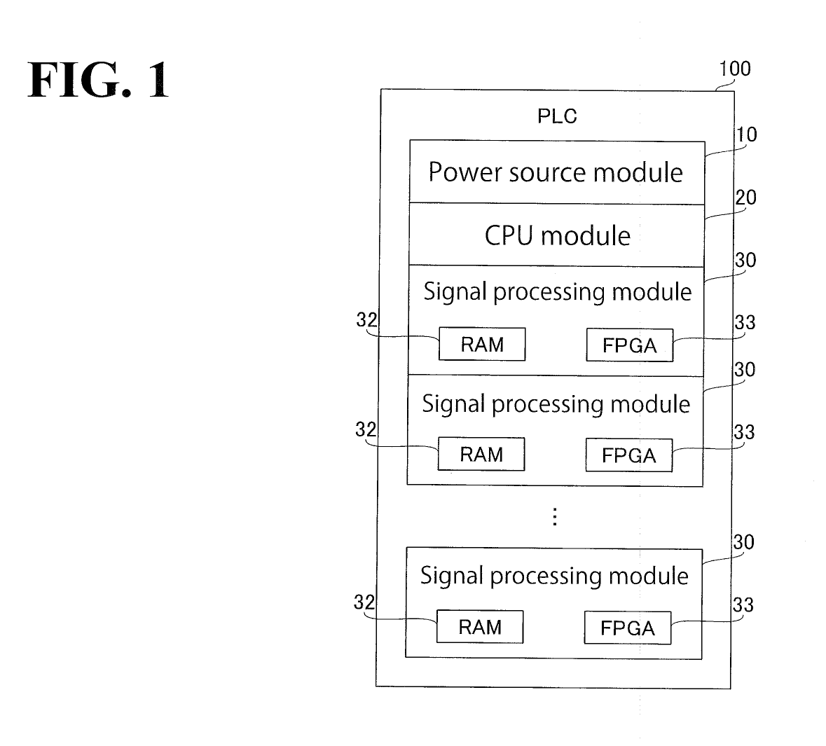

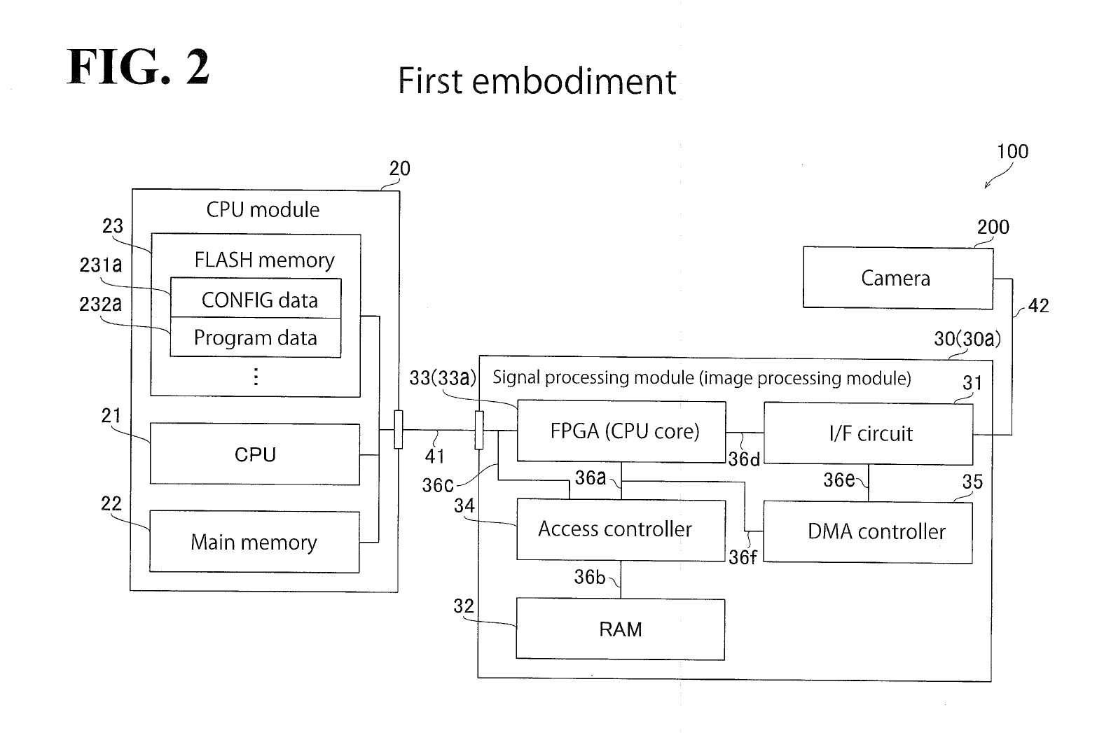

First, referring to FIGS. 1 and 2, a structure of a programmable logic controller (PLC) 100 according to a first embodiment will be described. The PLC 100 is an example of the “control apparatus”.

As shown in FIG. 1, the PLC 100 includes a power source module 10, a CPU module 20, and a plurality of signal processing modules 30. The power source module 10 supplies power to the whole PLC 100. The CPU module 20 controls the whole PLC 100. The plurality of signal processing modules 30 are connected to the power source module 10 and the CPU module 20. The CPU module 20 is an example of the “control module”.

The plurality of signal processing modules 30 are each connectable to various external input devices (such as a camera 200 shown in FIG. 2). The plurality of signal processing modules 30 perform various kinds of signal processing (image processing, for example) in accordance with various signals input from these external input devices (image data input from the camera 200, for example). The plurality of signal processing modules 30 have a common structure except for interfaces (see an I/F circuit 31 in FIG. 2) for connection to the external input devices. That is, merely changing the interfaces in various manners makes the plurality of signal processing modules 30 accommodate to various external input devices.

The plurality of signal processing modules 30 each include a random-access memory (RAM) 32 and a field programmable gate array (FPGA) 33. The FPGA 33 is programmable into a circuit having a desired function by a configuration. In the first embodiment, the configuration of the FPGA 33 is performed at power-up of the PLC 100, as described later.

Referring to FIG. 2, description will be made below with respect to a case in which one signal processing module 30 among the plurality of signal processing modules 30 (see FIG. 1) functions as an image processing module 30a to perform image processing of image data input from the camera 200. Specifically, the following description is concerning an example in which a configuration is performed with respect to the FPGA 33 of one signal processing module 30 among the plurality of signal processing modules 30 in order to program the FPGA 33 to function as a CPU core 33a of the image processing module 30a. The CPU core 33a is an example of the “processor”.

As shown in FIG. 2, the CPU module 20 and the signal processing module 30 functioning as the image processing module 30a are connected to each other through a parallel bus 41. In addition to the signal processing module 30 functioning as the image processing module 30a, the other signal processing modules 30 (not shown in FIG. 2, see FIG. 1) are also connected to the parallel bus 41.

The CPU module 20 includes a CPU 21, a main memory 22, and a non-volatile rewritable FLASH memory 23. The CPU 21 controls the whole CPU module 20. The main memory 22 stores, for example, operation programs of the CPU 21.

In the first embodiment, the FLASH memory 23 stores CONFIG data 231a and program data 232a. The CONFIG data 231a includes information (configuration information) for programming the FPGA 33 of the signal processing module 30 to function as the CPU core 33a of the image processing module 30a. The program data 232a includes operation programs for operating the FPGA 33 as the CPU core 33a after the configuration. The FLASH memory 23 also stores CONFIG data and program data corresponding to an FPGA 33 of each of the other signal processing modules 30 (not shown in FIG. 2, see FIG. 1), in addition to the CONFIG data and the program data corresponding to the FPGA 33 of the signal processing module 30 functioning as the image processing module 30a. The CONFIG data refers to element structure information for determining the logic structure, arrangement, and wiring of elements of the FPGA 33.

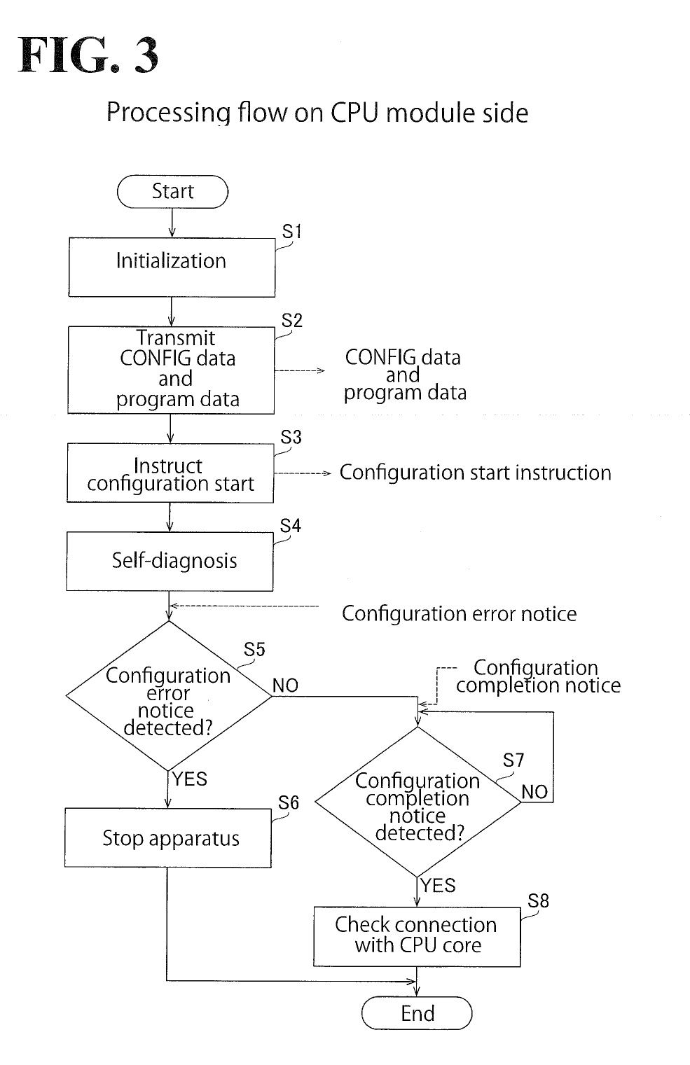

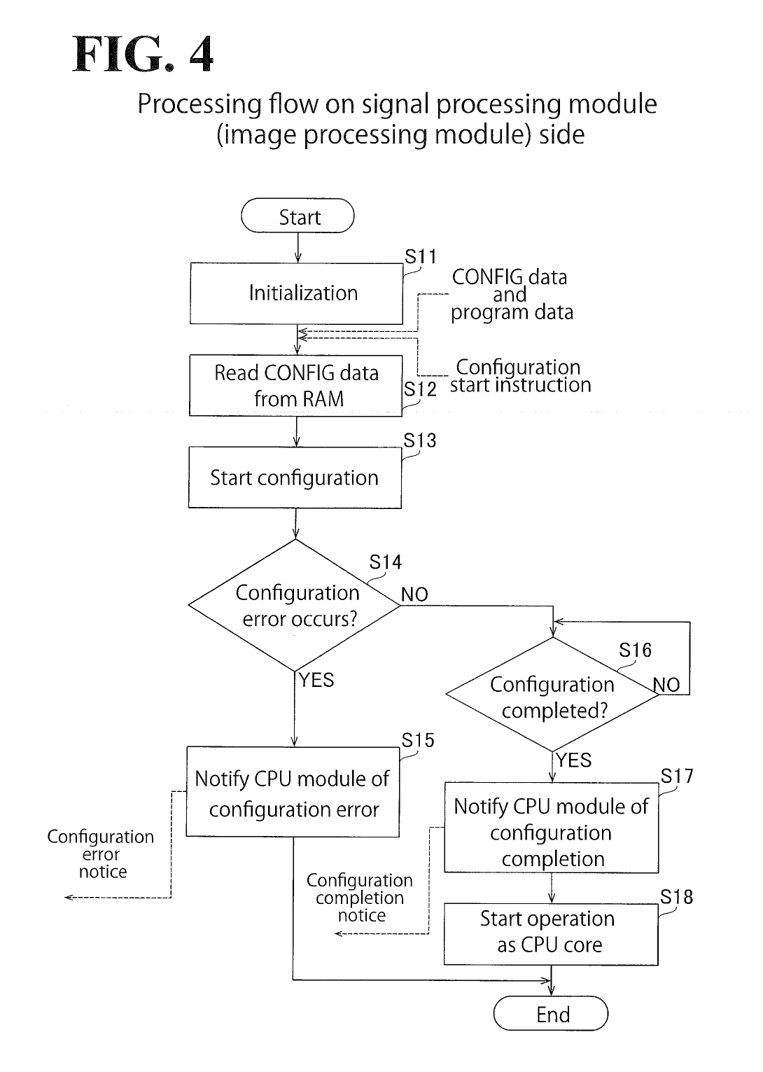

In the first embodiment, at power-up of the PLC 100, the CPU 21 of the CPU module 20 transmits the CONFIG data 231a and the program data 232a stored in the FLASH memory 23 to the signal processing module 30 functioning as the image processing module 30a so as to store the CONFIG data 231a and the program data 232a in the RAM 32 of the signal processing module 30 functioning as the image processing module 30a. After the CONFIG data 231a and the program data 232a have been stored in the RAM 32 of the signal processing module 30 functioning as the image processing module 30a, the CPU 21 outputs a signal of instruction to start a configuration (configuration start instruction, see FIGS. 3 and 4) to the FPGA 33 of the signal processing module 30 functioning as the image processing module 30a.

In the first embodiment, at the time of the configuration of the FPGA 33 of the signal processing module 30 functioning as the image processing module 30a, the CPU 21 of the CPU module 20 performs self-diagnosis simultaneously with the configuration. The self-diagnosis includes checking for validity of data stored in the main memory 22 and the FLASH memory 23, and checking as to whether the CPU 21 is operating normally. When configurations of the FPGAs 33 of the plurality of signal processing modules 30 (see FIG. 1) including the signal processing module 30 functioning as the image processing module 30a are performed simultaneously with each other, the self-diagnosis is performed simultaneously with the configurations of the FPGAs 33 of the plurality of signal processing modules 30.

In the first embodiment, if an error (configuration error) occurs at the time of the configuration of the FPGA 33 of the signal processing module 30, the signal processing module 30 outputs a configuration error notice (see FIGS. 3 and 4). Upon detection of the configuration error notice, the CPU 21 of the CPU module 20 stops the whole PLC 100 to stop the configuration of the FPGA 33. When the configuration of the FPGA 33 of the signal processing module 30 has been completed, the signal processing module 30 outputs a configuration completion notice (see FIGS. 3 and 4). Upon detection of the configuration completion notice, the CPU 21 of the CPU module 20 performs connection checking as to whether the connection of the CPU 21 with the FPGA 33 after the configuration (that is, the CPU core 33a) is normal.

As shown in FIG. 2, the image processing module 30a (signal processing module 30) includes the I/F circuit 31, the RAM 32, the FPGA 33, an access controller 34, and a direct memory access (DMA) controller 35. The DMA controller 35 is an example of the “direct memory access controller”.

The I/F circuit 31 is connectable to the camera 200 through a cable 42. The I/F circuit 31 includes devices such as an analog/digital converter (A/D converter) to convert analog image data input from the camera 200 through the cable 42 into digital image data.

The RAM 32 is a volatile random-access memory. The RAM 32 stores the CONFIG data 231a and the program data 232a transmitted from the CPU module 20 at power-up of the PLC 100.

The FPGA 33 is an SRAM field programmable gate array. When a configuration is performed based on the CONFIG data 231a stored in the RAM 32, the FPGA 33 is programmed into the CPU core 33a to perform image processing. The FPGA 33, once programmed as the CPU core 33a to perform image processing, operates based on the program data 232a stored in the RAM 32.

In the first embodiment, the FPGA 33 after the configuration (that is, the CPU core 33a) is accessible to the RAM 32. That is, the RAM 32 is used as a working memory for the FPGA 33 after the configuration (that is, the CPU core 33a) to perform image processing. The RAM 32 is accessible not only from the FPGA 33 after the configuration (that is, the CPU core 33a) but also from the CPU 21 of the CPU module 20.

The access controller 34 controls external access to the RAM 32 of the signal processing module 30 functioning as the image processing module 30a. Specifically, the access controller 34 has a function to allow or deny the FPGA 33 access to the RAM 32 through buses 36a and 36b, and has a function to allow or deny the CPU 21 of the CPU module 20 access to the RAM 32 through the parallel bus 41, a bus 36c, and the bus 36b. That is, the access controller 34 includes a program logic device (PLD) programmed to have a function to mediate a conflict of the right of using the bus 36b connected to the RAM 32.

For example, at power-up of the PLC 100, the access controller 34 imparts the right of using the bus 36b connected to the RAM 32 to the bus 36c side (CPU module 20 side). Thus, the CONFIG data 231a and the program data 232a transferred from the CPU module 20 through the parallel bus 41 at power-up of the PLC 100 are transferred to the RAM 32 through the buses 36c and 36b and stored in the RAM 32.

After the CONFIG data 231a and the program data 232a have been stored in the RAM 32, and when the CPU module 20 outputs a configuration start instruction (see FIGS. 3 and 4), the access controller 34 imparts the right of using the bus 36b connected to the RAM 32 to the bus 36a side (FPGA 33 side). Thus, when the configuration for programming the FPGA 33 as the CPU core 33a starts, the CONFIG data 231a stored in the RAM 32 is transferred to the FPGA 33 through the buses 36b and 36a.

In the first embodiment, the RAM 32 is capable of storing image data input from the camera 200 as well as the CONFIG data 231a and the program data 232a transmitted from the CPU module 20 at power-up of the PLC 100. The image processing module 30a includes the DMA controller 35. The DMA controller 35 allows the camera 200 connected to the image processing module 30a to have access to the RAM 32 without passing through the CPU core 33a.

Specifically, in the first embodiment, the image data input from the camera 200 is normally transferred from the I/F circuit 31 to the CPU core 33a through a bus 36d. From the CPU core 33a, the image data is then transferred to the RAM 32 through the bus 36a, the access controller 34, and the bus 36b. When a large amount of image data is input from the camera 200 at high transfer speed, the image data is transferred from the I/F circuit 31 to the RAM 32 without passing through the CPU core 33a; instead, through a bus 36e, the DMA controller 35, a bus 36f, the bus 36a, the access controller 34, and the bus 36b.

In the first embodiment, when an error (configuration error) occurs at the time of the configuration of the FPGA 33 described above, a signal to notify that a configuration error has occurred (configuration error notice, see FIGS. 3 and 4) is output from the FPGA 33 to the CPU module 20. When the configuration of the FPGA 33 is completed, a signal to notify that the configuration has been completed (configuration completion notice, see FIGS. 3 and 4) is output from the FPGA 33 to the CPU module 20.

In the configuration of the FPGA 33, the FPGA 33 may operate as a master or a slave. That is, in the signal processing module 30, the FPGA 33 may take the initiative to perform the configuration, or some other element such as the access controller 34 may replace the FPGA 33 to take the initiative to make the FPGA 33 perform the configuration.

Next, referring to FIGS. 3 and 4, processing flows of the PLC 100 at the time of the configuration of the FPGA 33 of the signal processing module 30 at power-up of the PLC 100 will be described. The CPU module 20 side and the signal processing module 30 (image processing module 30a) side will be described individually.

The following description is concerning an example in which the FPGA 33 of one signal processing module 30 among the plurality of signal processing modules 30 in the PLC 100 is programmed to function as the CPU core 33a of the image processing module 30a by the configuration.

First, referring to FIG. 3, a processing flow on the CPU module 20 side at power-up of the PLC 100 will be described.

On the CPU module 20 side, as shown in FIG. 3, the peripheral circuitry (bus controller, for example) of the CPU 21 inside the CPU module 20 is initialized at step S1. Then, the processing proceeds to step S2.

Next, at step S2, the CONFIG data 231a and the program data 232a stored in the FLASH memory 23 are transmitted to the RAM 32 of the signal processing module 30. The CONFIG data 231a and the program data 232a thus transmitted from the CPU module 20 to the signal processing module 30 are stored in the RAM 32 of the signal processing module 30. Then, the processing proceeds to step S3.

Next, at step S3, a signal of instruction to start the configuration (configuration start instruction) is output from the CPU 21 to the FPGA 33 of the signal processing module 30. Then, the processing proceeds to step S4.

Next, at step S4, the CPU 32 performs self-diagnosis. Specifically, the self-diagnosis includes checking of validity of the data stored in the main memory 22 and the FLASH memory 23, and checking as to whether the CPU 21 is operating normally. The self-diagnosis processing at step S4 is simultaneous with the configuration processing of the FPGA 33 of the signal processing module 30 (see steps S12 to S18 in FIG. 4, described later). Then, the processing proceeds to step S5.

In the first embodiment, the CPU 21 may perform processing to stop the whole PLC 100 if the self-diagnosis at step S4 results in detection of an abnormality in the data stored in the main memory 22 or the FLASH memory 23, or detection of an abnormality in the operation of the CPU 21.

If an error (configuration error) occurs at the time of the configuration of the FPGA 33 of the signal processing module 30, a configuration error notice is output from the signal processing module 30 (see steps S14 and S15 in FIG. 4, described later). At step S5, a determination is made as to whether the configuration error notice has been detected on the CPU module 20 side.

When at step S5 the configuration error notice is detected, the processing proceeds to step S6. At step S6, processing to stop the whole PLC 100 is performed, and the processing ends.

When at step S5 the configuration error notice is not detected, the processing proceeds to step S7. When the configuration of the FPGA 33 of the signal processing module 30 is completed, a configuration completion notice is output from the signal processing module 30 (see steps S16 and S17 in FIG. 4, described later). At step S7, a determination is made as to whether the configuration completion notice has been detected.

The processing at step S7 is repeated until the configuration completion notice is detected. When at step S7 the configuration completion notice is detected, the processing proceeds to step S8.

Next, at step S8, connection checking is performed to check whether the connection of the CPU 21 with the FPGA 33 after the configuration (that is, the CPU core 33a) is normal. Then, the processing ends. In the first embodiment, at step S8, when an abnormality is detected in the connection of the CPU 21 with the CPU core 33a, the CPU 21 may perform processing to stop the whole PLC 100.

Next, referring to FIG. 4, a processing flow on the signal processing module 30 side at power-up of the PLC 100 will be described.

On the signal processing module 30 side, as shown in FIG. 4, the SRAM and other components in the FPGA 33 are initialized at step S11. The processing proceeds to step S12 when at step S2 shown in FIG. 3, the CONFIG data 231a and the program data 232a are transmitted from the CPU module 20 and stored in the RAM 32, and when at step S3 shown in FIG. 3, the configuration start instruction output from the CPU module 20 is detected on the signal processing module 30 side.

Next, at step S12, the CONFIG data 231a, which has been transmitted from the CPU module 20 and stored in the RAM 32 at step S2 shown in FIG. 3, is read from the RAM 32. Then, the processing proceeds to step S13.

Next, at step S13, based on the CONFIG data 231a read from the RAM 32 at step S12, the configuration of the FPGA 33 starts. Then, the processing proceeds to step S14.

Next, at step S14, a determination is made as to whether an error (configuration error) has occurred at the time of the configuration of the FPGA 33. When at step S14a determination is made to the effect that the configuration error has occurred, the processing proceeds to step S15. At step S15, a signal to notify that the configuration error has occurred (configuration error notice) is output to the CPU module 20, and the processing ends.

When at step S14a determination is made to the effect that the configuration error has not occurred, the processing proceeds to step S16. Then, at step S16, a determination is made as to whether the configuration has been completed. The processing at step S16 is repeated until a determination is made to the effect that the configuration has been completed.

When at step S16a determination is made to the effect that the configuration has been completed, the processing proceeds to step S17. Then, at step S17, a signal to notify that the configuration has been completed (configuration completion notice) is output to the CPU module 20, and the processing proceeds to step S18.

At step S18, based on the program data 232a transmitted from the CPU 21 and stored in the RAM 32 at step S2 shown in FIG. 3, the operation of the FPGA 33 as the CPU core 33a starts, and the processing ends. The processing at steps S12 through S18 (configuration processing of the FPGA 33) is performed simultaneously with the self-diagnosis processing of the CPU module 20 at step S4 shown in FIG. 3.

In the first embodiment, as described above, the signal processing module 30 (image processing module 30a) of the PLC 100 includes the volatile RAM 32. The volatile RAM 32 stores the CONFIG data 231a (configuration information for programming the FPGA 33 of the signal processing module 30 to function as the CPU core 33a of the image processing module 30a) obtained from the CPU module 20 of the PLC 100. The FPGA 33 that has undergone the configuration to function as the CPU core 33a is accessible to the RAM 32. Thus, the volatile RAM 32 of the signal processing module 30 to store the CONFIG data 231a of the FPGA 33 may also be used as a memory to store various data used when the FPGA 33 after the configuration operates as the CPU core 33a. This eliminates the need for an additional memory to store various data used when the FPGA 33 after the configuration operates as the CPU core 33a; the memory to store the CONFIG data 231a of the FPGA 33 suffices. This, in turn, reduces the signal processing module 30 in size.

In the first embodiment, the RAM 32 of the signal processing module 30 (image processing module 30a) also stores the program data 232a of the CPU core 33a, so that the CPU core 33a is operated based on the program data 232a stored in the RAM 32. This eliminates the need for an additional memory to store the program data 232a of the CPU core 33a; the RAM 32 suffices. This, in turn, further reduces the signal processing module 30 in size.

In the first embodiment, as described above, the RAM 32 of the signal processing module 30 (image processing module 30a) is used as a working memory of the CPU core 33a. This eliminates the need for an additional working memory of the CPU core 33a; the RAM 32 suffices. This, in turn, further reduces the signal processing module 30 in size.

In the first embodiment, as described above, the RAM 32 of the signal processing module 30 (image processing module 30a) is also accessible from the CPU 21 of the CPU module 20. This enhances control convenience in comparison with the case where the RAM 32 of the signal processing module 30 (image processing module 30a) is not accessible from the CPU 21 of the CPU module 20.

In the first embodiment, as described above, the access controller 34 of the signal processing module 30 (image processing module 30a) mediates a conflict of the right of using the bus 36b connected to the RAM 32 in order to control access to the RAM 32. Thus, the access controller 34 readily avoids a conflict of access to the RAM 32.

In the first embodiment, as described above, the configuration of the FPGA 33 of the signal processing module 30 (image processing module 30a) is performed simultaneously with the self-diagnosis of the CPU module 20. This enhances efficiency of the configuration of the FPGA 33 of the signal processing module 30 (image processing module 30a) and efficiency of the self-diagnosis of the CPU module 20.

In the first embodiment, as described above, a plurality of signal processing modules 30 are provided, and the configuration of the FPGA 33 of each of the plurality of signal processing modules 30 is performed simultaneously with the self-diagnosis of the CPU module 20. Even with the plurality of signal processing modules 30, efficiency improves in the configuration of the FPGA 33 in each of the plurality of signal processing modules 30 and in the self-diagnosis of the CPU module 20.

In the first embodiment, as described above, the signal processing module 30 (image processing module 30a) includes the DMA controller 35 to allow the camera 200 connected to the signal processing module 30 (image processing module 30a) to have access to the RAM 32 without passing through the CPU core 33a. For example, when a large amount of image data is transferred between the camera 200 and the signal processing module 30 at high transfer speed, the DMA controller 35 serves to directly transfer the image data between the camera 200 and the RAM 32, without passing the image data through the CPU core 33a. This, as a result, increases the transfer speed of the image data between the camera 200 and the signal processing module 30 (image processing module 30a), and reduces the load on the CPU core 33a at the time of transfer of the image data.

In the first embodiment, as described above, the RAM 32 of the signal processing module 30 (image processing module 30a) also stores image data input from the camera 200 connected to the signal processing module 30 (image processing module 30a). This eliminates the need for an additional memory to store image data input from the camera 200; the RAM 32 suffices. This, in turn, further reduces the signal processing module 30 in size.

### Second Embodiment

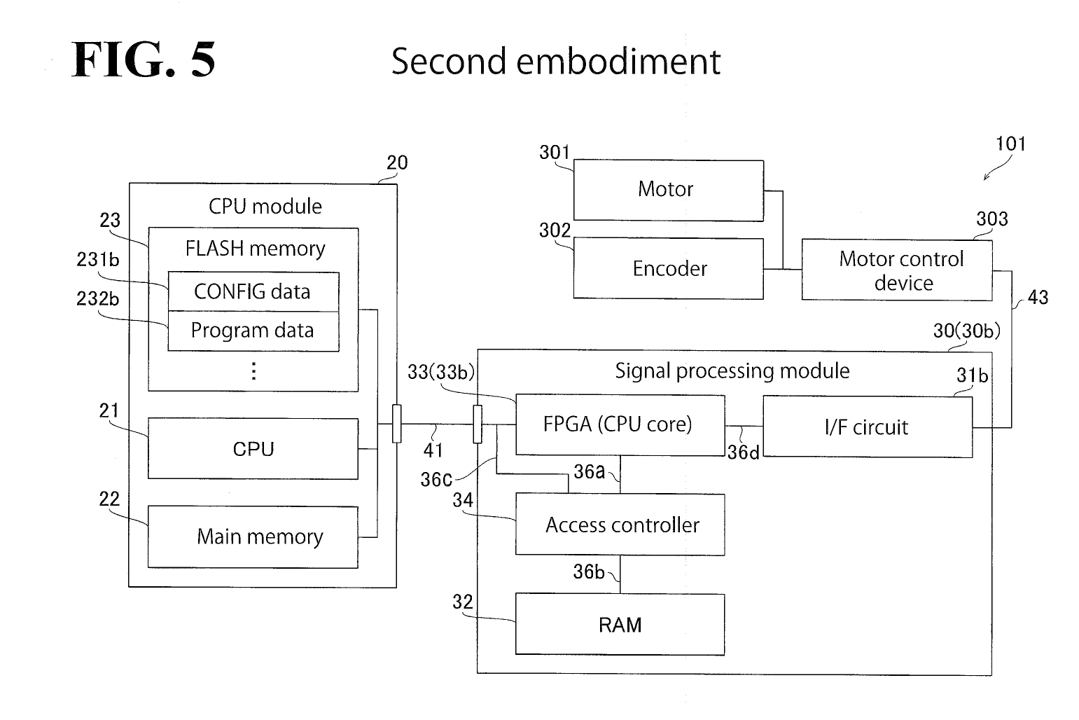

Next, referring to FIG. 5, a structure of a programmable logic controller (PLC) 101 according to a second embodiment will be described. The second embodiment is different from the first embodiment, in which the camera 200 is connected to the signal processing module 30. The following description of the second embodiment is concerning an example in which a motor control device 303 connected to a motor 301 and an encoder 302 is connected to a signal processing module 30. The PLC 101 is an example of the “control apparatus”. The motor control device 303 is an example of the “external input device”.

As shown in FIG. 5, the motor control device 303, which is connected to the motor 301 and the encoder 302, is connected through a cable 43 to the signal processing module 30 of the PLC 101 according to the second embodiment. In the second embodiment, a configuration is performed at power-up of the PLC 101 in order to program an FPGA 33 of the signal processing module 30 to function as a CPU core 33b of a signal processing module 30b for signal processing with respect to, for example, feedback from the encoder 302.

In the second embodiment, an I/F circuit 31b of the signal processing module 30 includes a circuit corresponding to an analog signal or a PWM signal output to the motor control device 303 through the cable 43.

In the second embodiment, a FLASH memory 23 of a CPU module 20 of the PLC 101 stores CONFIG data 231b and program data 232b. The CONFIG data 231b includes information (configuration information) for programming the FPGA 33 of the signal processing module 30 to function as the CPU core 33b. The program data 232b includes operation programs for operating the FPGA 33 as the CPU core 33b after the configuration. Similarly to the first embodiment, the CONFIG data 231b and the program data 232b are transmitted from the CPU module 20 to the signal processing module 30b at power-up of the PLC 101, and stored in a RAM 32 of the signal processing module 30b.

In the second embodiment, the signal processing module 30 includes the RAM 32 and the FPGA 33, similarly to the first embodiment. The RAM 32 is a volatile random-access memory, and the FPGA 33 is an SRAM field programmable gate array. By a configuration performed based on the CONFIG data 231b stored in the RAM 32, the FPGA 33 is programmed into the CPU core 33b for signal processing with respect to, for example, feedback from the encoder 302 (motor control). The FPGA 33 thus programmed as the CPU core 33b for signal processing operates based on the program data 232b stored in the RAM 32.

In the second embodiment, the FPGA 33 after the configuration (that is, CPU core 33b) is accessible to the RAM 32, similarly to the first embodiment. In other words, the RAM 32 is used as a working memory when the FPGA 33 after the configuration (the CPU core 33b) performs signal processing with respect to, for example, feedback from the encoder 302.

The second embodiment is otherwise similar to the first embodiment (see FIGS. 1 and 2).

Also, the processing flow at power-up of the PLC 101 according to the second embodiment (processing flow of programming by the configuration of the FPGA 33 to function as the CPU core 33b) is similar to the first embodiment (see FIGS. 3 and 4).

Furthermore, the second embodiment provides similar advantageous effects to the advantageous effects provided in the first embodiment.

It should be noted that the embodiments disclosed in this specification are provided for exemplary purposes only and should not be construed in a limiting sense.

For example, the first and second embodiments are concerning the PLC (control apparatus) made up of the CPU module (control module) including the CPU, and the signal processing module including the FPGA (field programmable gate array) and the RAM (volatile memory). Another possible example is a general signal processing apparatus including a signal processing module provided with a field programmable gate array and a volatile memory.

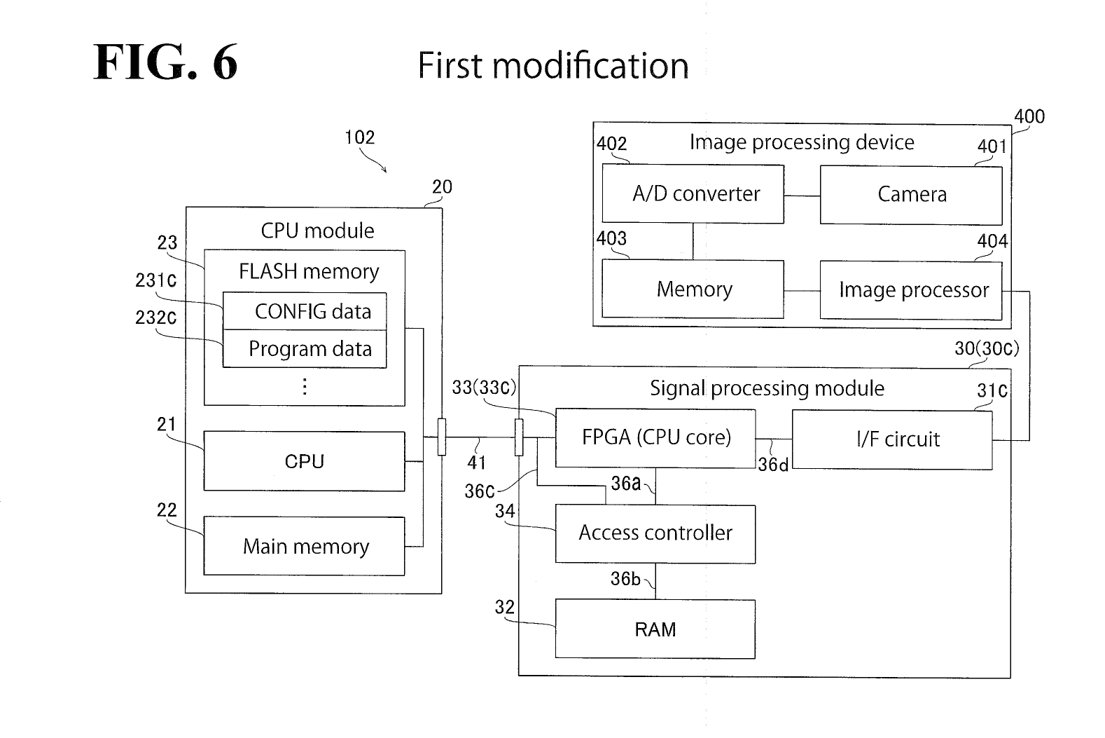

As shown in FIG. 2, the first embodiment is concerning an example in which the signal processing module 30 of the PLC 100 functions as the image processing module 30a connected to the camera 200. Another possible example is a first modification of the first embodiment shown in FIG. 6. A signal processing module 30 of a PLC 102 may function as a signal processing module 30c connected to an image processing device 400 including a camera 401, an analog/digital converter (A/D converter) 402, a memory 403, and an image processor 404. The PLC 102 is an example of the “control apparatus”. The image processing device 400 is an example of the “external input device”.

In the first modification shown in FIG. 6, by a configuration, an FPGA 33 of the signal processing module 30 is programmed to function as a CPU core 33c of a signal processing module 30c for predetermined signal processing with respect to image data that has undergone image processing using the A/D converter 402 and the image processor 404 in the image processing device 400. In the first modification shown in FIG. 6, an I/F circuit 31c of the signal processing module 30 includes a circuit having a serial communication function.

The first modification shown in FIG. 6 is similar to the first embodiment shown in FIGS. 1 to 4 in that the configuration is performed based on CONFIG data 231c transmitted from a FLASH memory 23 of a CPU module 20 and stored in a volatile RAM 32 of the signal processing module 30 (30c). The FPGA 33 after the configuration (that is, CPU core 33c) according to the first modification shown in FIG. 6 operates based on program data 232c transmitted from the FLASH memory 23 of the CPU module 20 and stored in the RAM 32 of the signal processing module 30 (30c).

The first modification shown in FIG. 6 is similar to the first embodiment shown in FIGS. 1 to 4 in that the FPGA 33 after the configuration (that is, CPU core 33c) is accessible to the RAM 32. That is, the RAM 32 is used as a working memory for the FPGA 33 after the configuration (that is, CPU core 33c) to perform predetermined signal processing.

In the first modification shown in FIG. 6, the data that has undergone image processing using the image processor 404 of the image processing device 400 is input to the signal processing module 30c. Hence, the volume of the data input to the signal processing module 30c is relatively small. Consequently, the first modification shown in FIG. 6 is different from the first embodiment shown in FIGS. 1 to 4 in that it is not necessary to provide the signal processing module 30c with a direct memory access controller (DMA controller) to allow the image processing device 400 to have access to the RAM 32 without passing through the FPGA 33 (CPU core 33c). This simplifies the structure of the signal processing module 30c.

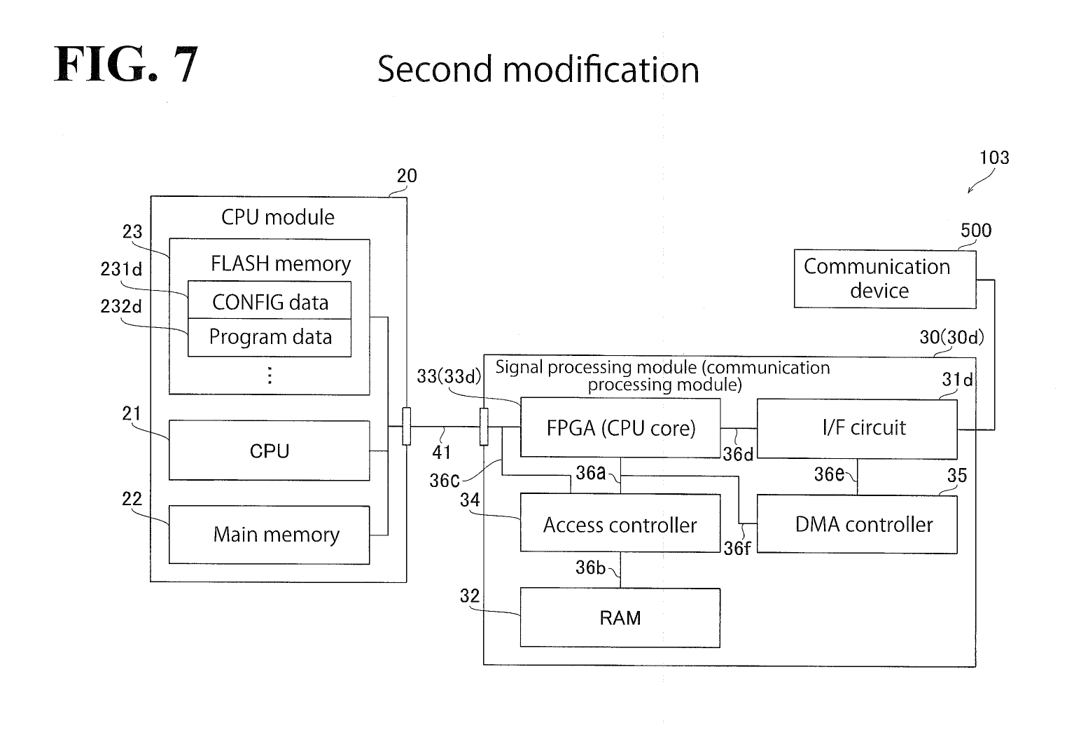

As shown in FIG. 2, the first embodiment is concerning an example in which the signal processing module 30 of the PLC 100 functions as the image processing module 30a connected to the camera 200. Another possible example is a second modification of the first embodiment shown in FIG. 7. A signal processing module 30 of a PLC 103 may function as a communication processing module 30d connected to a communication device 500. The PLC 103 is an example of the “control apparatus”. The communication device 500 is an example of the “external input device”.

In the second modification shown in FIG. 7, by a configuration, an FPGA 33 of the signal processing module 30 is programmed to function as a CPU core 33d of the communication processing module 30d for predetermined signal processing with respect to data input from the communication device 500. In the second modification shown in FIG. 7, an I/F circuit 31d of the signal processing module 30 includes a circuit having a serial communication function.

The second modification shown in FIG. 7 is similar to the first embodiment shown in FIGS. 1 to 4 in that the configuration is performed based on CONFIG data 231d transmitted from a FLASH memory 23 of a CPU module 20 and stored in a volatile RAM 32 of the signal processing module 30d. The FPGA 33 after the configuration (that is, CPU core 33d) according to the second modification shown in FIG. 7 operates based on program data 232d transmitted from the FLASH memory 23 of the CPU module 20 and stored in the RAM 32 of the signal processing module 30d.

The second modification shown in FIG. 7 is similar to the first embodiment shown in FIGS. 1 to 4 in that the FPGA 33 after the configuration (that is, CPU core 33d) is accessible to the RAM 32. That is, the RAM 32 is used as a working memory for the FPGA 33 after the configuration (that is, CPU core 33d) to perform predetermined signal processing with respect to data input from the communication device 500.

In the second modification shown in FIG. 7, when the communication device 500 is a device for high-speed communication, a relatively large volume of data is input from the communication device 500 to the signal processing module 30 (communication processing module 30d). Consequently, in the second modification shown in FIG. 7, the signal processing module 30 (communication processing module 30d) includes a DMA controller 35, similarly to the first embodiment shown in FIGS. 1 to 4. Thus, when a large volume of data is input from the communication device 500 at high transfer speed, the large volume of data is directly transferred to the RAM 32, without passing through the CPU core 33d. This, as a result, increases the speed of data transfer in the signal processing module 30 (communication processing module 30d), and reduces the load on the CPU core 33d at the time of the data transfer.

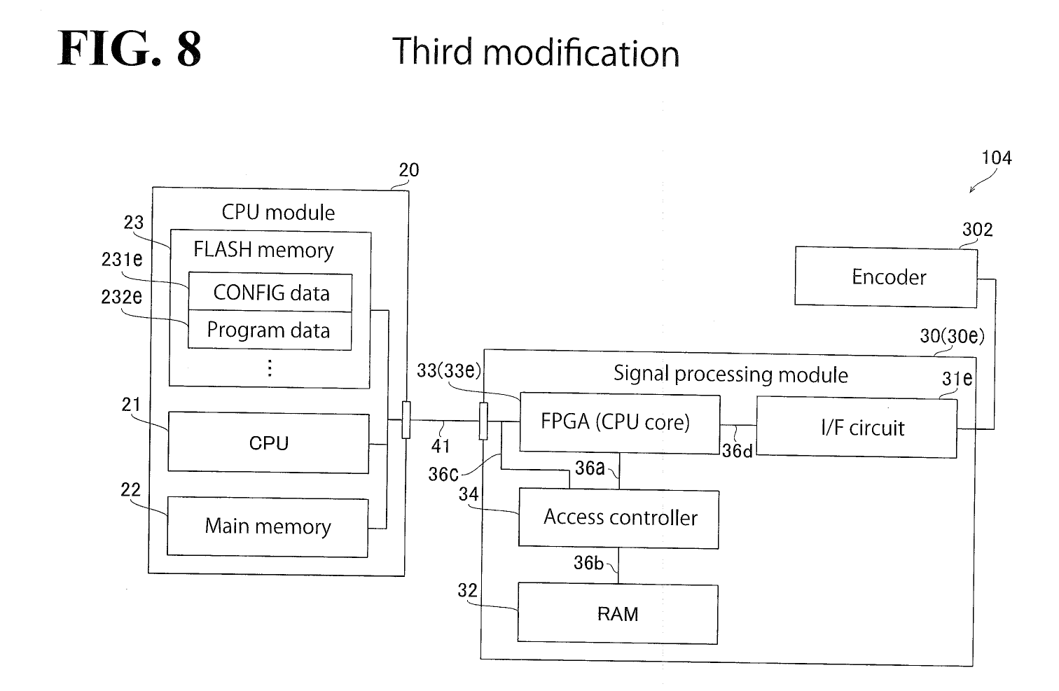

As shown in FIG. 5, the second embodiment is concerning an example in which the signal processing module 30 of the PLC 101 functions as the signal processing module 30b connected to the motor control device 303, which is connected to the motor 301 and the encoder 302. Another possible example is a third modification of the first embodiment shown in FIG. 8. A signal processing module 30 of a PLC 104 may function as a signal processing module 30e directly connected to an encoder 302. The PLC 104 is an example of the “control apparatus”. The encoder 302 is an example of the “external input device”.

In the third modification shown in FIG. 8, by a configuration, an FPGA 33 of the signal processing module 30 is programmed to function as a CPU core 33e of the signal processing module 30e for predetermined signal processing with respect to a signal input from the encoder 302. In the third modification shown in FIG. 8, an I/F circuit 31e of the signal processing module 30 includes a circuit corresponding to a signal input from the encoder 302.

The third modification shown in FIG. 8 is similar to the first embodiment shown in FIGS. 1 to 4 in that the configuration is performed based on CONFIG data 231e transmitted from a FLASH memory 23 of a CPU module 20 and stored in a volatile RAM 32 of the signal processing module 30 (30e). The FPGA 33 after the configuration (that is, CPU core 33e) according to the third modification shown in FIG. 8 operates based on program data 232e transmitted from the FLASH memory 23 of the CPU module 20 and stored in the RAM 32 of the signal processing module 30 (30e).

The third modification shown in FIG. 8 is similar to the first embodiment shown in FIGS. 1 to 4 in that the FPGA 33 after the configuration (that is, CPU core 33e) is accessible to the RAM 32. That is, the RAM 32 is used as a working memory for the FPGA 33 after the configuration (that is, CPU core 33e) to perform predetermined signal processing.

In the third modification shown in FIG. 8, the data input from the encoder 302 to the signal processing module 30e is made up of a pulse signal and other signals, and accordingly, the volume of the data is relatively small. Consequently, the third modification shown in FIG. 8 is different from the first embodiment shown in FIGS. 1 to 4 in that it is not necessary to provide the signal processing module 30e with a direct memory access controller (DMA controller) to allow the encoder 302 to have access to the RAM 32 without passing through the FPGA 33 (CPU core 33e). This simplifies the structure of the signal processing module 30e.

The first and second embodiments are concerning an example in which the access controller 34 includes a program logic device (PLD) programmed to have a function to mediate a conflict of the right of using the bus 36b connected to the RAM 32. It is also possible to use a dedicated device instead of the PLD.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A control apparatus comprising a signal processing module, the signal processing module comprising:
a field programmable gate array; and
a volatile memory which is configured to store configuration information of the field programmable gate array and to which the field programmable gate array has access after a configuration of the field programmable gate array.

2. A control apparatus comprising a signal processing module, the signal processing module comprising:
a field programmable gate array; and
a volatile memory which is configured to store configuration information of the field programmable gate array and to which the field programmable gate array has access after a configuration of the field programmable gate array,
wherein when the configuration of the field programmable gate array is performed based on the configuration information stored in the volatile memory, the field programmable gate array is configured to function as a processor of the signal processing module,
wherein the volatile memory is configured to store an operation program of the processor, and
wherein the processor is configured to operate based on the operation program stored in the volatile memory.

3. The control apparatus according to claim 2, wherein the volatile memory is usable as a working memory of the processor.

4. The control apparatus according to claim 1, further comprising a control module comprising a central processing unit,
wherein the volatile memory is accessible from the central processing unit.

5. The control apparatus according to claim 1, wherein the signal processing module further comprises an access controller configured to control access to the volatile memory.

6. The control apparatus according to claim 5, wherein the access controller is configured to mediate a conflict of a right of using a bus connected to the volatile memory so as to control the access to the volatile memory.

7. The control apparatus according to claim 1, further comprising a control module comprising a central processing unit,
wherein the configuration of the field programmable gate array is performed simultaneously with a self-diagnosis of the control module.

8. The control apparatus according to claim 7,
wherein the signal processing module comprises a plurality of signal processing modules, and
wherein the configuration of the field programmable gate array of each of the plurality of signal processing modules is performed simultaneously with the self-diagnosis of the control module.

9. The control apparatus according to claim 1,
wherein when the configuration of the field programmable gate array is performed based on the configuration information stored in the volatile memory, the field programmable gate array is configured to function as a processor of the signal processing module, and
wherein the signal processing module further comprises a direct memory access controller configured to allow an external input device connected to the signal processing module to have access to the volatile memory without passing through the processor.

10. The control apparatus according to claim 1, wherein the volatile memory is configured to store data input from an external input device connected to the signal processing module.

11. The control apparatus according to claim 1, wherein the field programmable gate array comprises an SRAM field programmable gate array.

12. A method for controlling a control apparatus,
the control apparatus comprising:
a control module comprising a central processing unit; and
a signal processing module comprising:
a field programmable gate array; and
a volatile memory,
the method comprising:
obtaining configuration information of the field programmable gate array from the control module and storing the configuration information in the volatile memory;
performing a configuration based on the configuration information stored in the volatile memory so as to make the field programmable gate array function as a processor of the signal processing module; and
allowing the processor to have access to the volatile memory so as to perform processing using the processor.

13. The control apparatus according to claim 2, further comprising a control module comprising a central processing unit,
wherein the volatile memory is accessible from the central processing unit.

14. The control apparatus according to claim 3, further comprising a control module comprising a central processing unit,
wherein the volatile memory is accessible from the central processing unit.

15. The control apparatus according to claim 2, wherein the signal processing module further comprises an access controller configured to control access to the volatile memory.

16. The control apparatus according to claim 3, wherein the signal processing module further comprises an access controller configured to control access to the volatile memory.

17. The control apparatus according to claim 4, wherein the signal processing module further comprises an access controller configured to control access to the volatile memory.

18. The control apparatus according to claim 13, wherein the signal processing module further comprises an access controller configured to control access to the volatile memory.

19. The control apparatus according to claim 14, wherein the signal processing module further comprises an access controller configured to control access to the volatile memory.

20. The control apparatus according to claim 15, wherein the access controller is configured to mediate a conflict of a right of using a bus connected to the volatile memory so as to control the access to the volatile memory.
